(19) United States
(12) Patent Application Publication
(10) Pub. No.: US 2005/0105012 A1
(43) Pub. Date: May 19, 2005

(54) Display

(76) Inventors: Sung Ki Kim, Yongin-si (KR); Won Nyath Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/965,730

(22) Filed: Oct. 18, 2004

(30) Foreign Application Priority Data
Oct. 28, 2003 (KR) 2003-76464
Jan. 20, 2004 (KR) 2004-04284
Mar. 12, 2004 (KR) 2004-16983

(51) Int. Cl. G02F 1/1333

(52) U.S. Cl. 349/58

(57) ABSTRACT

A display comprising a display module to form an image, the display including: a front casing provided in front of the display module; a rear casing provided at the back of the display module; an air slit formed on at least one of the front casing and the rear casing; and at least one pressure wave generator that is provided between the front casing and the rear casing to cool heat generated from the display module and to generate a pressure wave in a frequency in which an operation noise thereof can be prevented.

### CROSS-REFERENCE TO RELATED APPLICATIONS

This application claims the benefit of Korean Patent Application No. 2003-75464, filed Oct. 28, 2003 in the Korean Intellectual Property Office, the benefit of Korean Patent Application No 2004-04284, filed Jan. 20, 2004 in the Korean Intellectual Property Office, and the benefit of Korean Patent Application No 2004-16983, filed Mar. 12, 2004 in the Korean Intellectual Property Office, the disclosures all three of which are incorporated herein in its entirely and by reference.

### BACKGROUND OF THE INVENTION

1. Field of the Invention

The present general inventive concept relates to a display, and more particularly, to a display having an improved structure to cool heat generated from a display module.

2. Description of the Related Art

Generally, a display refers to monitors for a TV, a computer and related devices and can include a display module to form an image and a cover to support the display module.

The display module forms the image by using a cathode ray tube (CRT), a liquid crystal display (LCD), and a plasma display panel (PDP). The display module generates heat when operated and a variety of techniques have been developed to discharge the heat. As the display module becomes larger, it becomes an important problem to discharge the heat.

A display including a flat display module having a flat display panel, a circuit board to drive the flat display panel and a casing to support the flat display panel is used as an example.

In a conventional display, to discharge heat generated from the display panel and the circuit board, an air slit is provided on the casing to circulate inner air and outer air of the display. However, as the display has become larger, the air slit cannot sufficiently cool the display panel and the circuit board, so that a cooling fan or a cooling pump is used to produce compulsive air turbulence.

However, the cooling fan or the cooling pump of the conventional display causes an operational noise when operated. Further, as the display has become thinner to minimize a space to mount the display, it is difficult to mount the cooling fan or the cooling pump in the thin display. Moreover, the cooling fan and the cooing pump of the conventional display are provided in the vicinity of a heating area, so that they can only partially cool the heat. Thus, a cooling apparatus that can cool heat in a broader area is required.

### SUMMARY OF THE INVENTION

Accordingly, it is an aspect of the present general inventive concept to provide an apparatus and method to help cool a display module and to prevent operational noise from the display module.

Additional aspects and/or advantages of the present general inventive concept will be set forth in part in the description which follows and, in part, will be obvious from the description, or may be learned by practice of the present general inventive concept.

The foregoing and/or other aspects and advantages of the present general inventive concept can be achieved by providing a display including a display module to form an image, the display including: a front casing provided in front of the display module; a rear casing provided at the back of the display module; an air slit formed on at least one of the front casing and the rear casing; and at least one pressure wave generator that is provided between the front casing and the rear casing to cool heat generated from the display module and generates a pressure wave in a frequency in which an operation noise thereof can be prevented.

According to an aspect of the present general inventive concept, the pressure wave generator can include a piezoelectric device that is operated in the frequency and a piezoelectric device supporter that supports the piezoelectric device and is connected with a cable to supply power to the piezoelectric device.

According to an aspect of the present general inventive concept, the pressure wave generator further can include a vibrator that is connected to the piezoelectric device and generates a pressure wave depending on an operation of the piezoelectric device.

According to an aspect of the present general inventive concept, the pressure wave generator can be provided at least in a pair each to be connected to first opposite ends of the vibrator.

According to an aspect of the present general inventive concept, the pressure wave generator can be provided at least in quadruplet each to be connected to the first opposite ends of the vibrator and second opposite ends provided in a traverse direction of the first opposite ends.

According to an aspect of the present general inventive concept, the vibrator can be a substantially plate shape and made of elastic material so as to be expanded and contracted in a direction in which the vibrator is connected to the piezoelectric device.

According to an aspect of the present general inventive concept, the cable connected with the piezoelectric device can be connected to a circuit board of the display module to supply power to the piezoelectric device.

According to an aspect of the present general inventive concept, the pressure wave generator can include a signal generator to generate a signal corresponding to the frequency, an amplifier to amplify a signal received from the signal generator and a speaker to generate a pressure wave according to a signal received from the signal generator and the amplifier.

According to an aspect of the present general inventive concept, the pressure wave generator further can include a cover that forms an external appearance of the pressure wave generator and has at least one hole to generate the pressure wave with concentration.

According to an aspect of the present general inventive concept, the hole of the cover can be shaped like a funnel having an inner opening broader than an outer opening.

According to an aspect of the present general inventive concept, the pressure wave generator can be provided inside of the rear casing to be spaced apart from the circuit board of the display module.

According to an aspect of the present general inventive concept, the pressure wave generator can be provided on an inner lower part of the rear casing.

According to an aspect of the present general inventive concept, the air slit is provided on the rear casing and the pressure wave generator can be provided inside the rear casing to be positioned in the vicinity of the air slit.

According to an aspect of the present general inventive concept, the pressure wave generator can generate a pressure wave in frequencies approximately 10 Hz through 50 Hz.

According to an aspect of the present general inventive concept, the pressure wave generator can generate a pressure wave in frequencies approximately 25 Hz through 35 Hz.

The foregoing and/or other aspects of the present general inventive concept can also be achieved by providing pressure wave generator comprising: at least one piezoelectric device; a vibrator that is connected to a first end of the piezoelectric device to generate a pressure wave in a predetermined frequency by the piezoelectric device; and a piezoelectric device supporter that is connected to a second end of the piezoelectric device to support the piezoelectric device.

According to an aspect of the present general inventive concept, wherein the piezoelectric device supporter can be provided outside the vibrator, the piezoelectric device is provided in a plurality between the piezoelectric device supporter and the vibrator.

According to an aspect of the present general inventive concept, the plurality of piezoelectric devices can be provided between the piezoelectric device supporter and the vibrator at equal intervals.

According to an aspect of the present general inventive concept, the vibrator can be substantially plate shaped and made of elastic material that is expanded and contracted in a direction in which the vibrator is connected to the piezoelectric device.

According to an aspect of the present general inventive concept, an end of each of the plurality of piezoelectric devices can be reciprocated simultaneously in the same direction with respect to the piezoelectric device supporter.

According to an aspect of the present general inventive concept, frequencies of a pressure wave generated by the vibrator can be approximately 10 Hz through 50 Hz.

The foregoing and/or other aspects of the present general inventive concept can also be achieved by providing a display including a display module to form an image and a casing provided outside the display module, the display comprising: an air slit formed on the casing; and at least one pressure wave generator to generate a pressure wave and transfer the pressure wave toward the air slit, and the pressure wave generator comprises at least one piezoelectric device; a vibrator that is connected to a first end of the piezoelectric device to generate a pressure wave in a predetermined frequency by the piezoelectric device; and a piezoelectric device supporter that is connected to a second end of the piezoelectric device to support the piezoelectric device.

According to an aspect of the present general inventive concept, the piezoelectric device supporter can be provided outside the vibrator, and the pressure wave generator is provided in a plurality between the piezoelectric device supporter and the vibrator.

According to an aspect of the present general inventive concept, the pressure wave generator can be provided on at least one of the display module and the casing to be spaced apart from the air slit.

According to an aspect of the present general inventive concept, the air slit can be provided on an upper part of the casing, and the pressure wave generator can be provided in the display module to transfer a pressure wave generated from the pressure wave generator toward the air slit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a display according to the present general inventive concept;

FIG. 2 is a sectional view of a display according to an embodiment of the present general inventive concept, taken along the line II-II in FIG. 1;

FIG. 3 is a perspective view of a pressure wave generator provided in the display in FIG. 2;

FIG. 4 is a sectional view of the pressure wave generator in FIG. 3, taken along the line III-III in FIG. 3;

FIG. 5 is a perspective view of a plurality of pressure wave generators provided in the display according to an embodiment of the present general inventive concept;

FIG. 6 is a sectional view of a display according to a further embodiment of the present general inventive concept;

FIG. 7 is a perspective view of a pressure wave generator provided in the display in FIG. 6;

FIG. 8 is a sectional view of the pressure wave generator in FIG. 7, taken along the line VIII-VIII in FIG. 7;

FIG. 9 is a sectional view of a display according to a an embodiment of the present general inventive concept;

FIG. 10 is a perspective view of a pressure wave generator provided in the display in FIG. 9;

FIG. 11 is a graph showing a cooing efficiency of the display according to an embodiment the present general inventive concept;

FIG. 12 is a sectional view of a display according to an embodiment of the present general inventive concept; and

FIGS. 13 and 14 are sectional views showing operations of the pressure wave generator provided in the display in FIG. 12.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

A display according to the present general inventive concept refers to monitors for a TV, a computer and related devices and can include a cathode ray tube (CRT), a liquid crystal display (LCD), a plasma display panel (PDP), or any other visual output device.

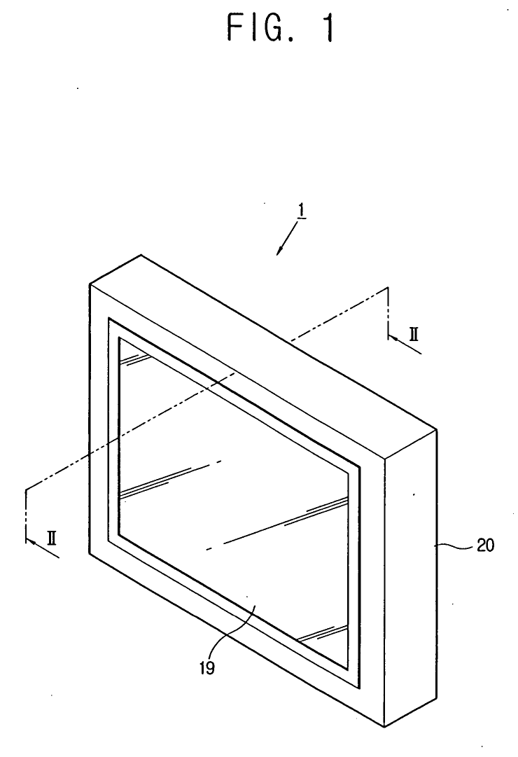

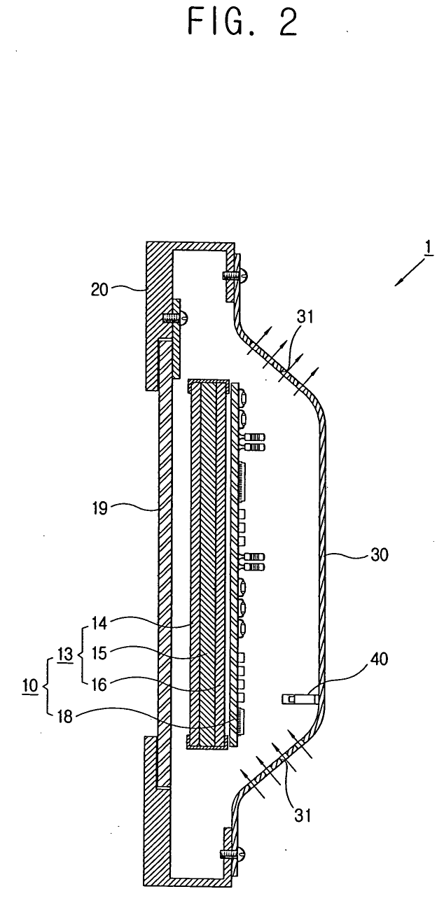

Described below is an example using a Plasma Display Panel (PDP) and a circuit board to drive the PDP. FIG. 1 is a perspective view of a display according to the present general inventive concept. FIG. 2 is a sectional view of a display according to an embodiment of the present general inventive concept, taken along the line II-II in FIG. 1.

As shown in FIGS. 1 and 2, a display 1 according to an embodiment of the present general inventive concept can include a display module 10 to form an image, a front casing 20 provided in front of the display module 10, a rear casing 30 provided at the back of the display module 10 and at least one pressure wave generator 40 provided between the front casing 20 and the rear casing 30 to cool heat from the display module 10 and to generate a pressure wave in a frequency to prevent operation noise.

The display module 10 can include a PDP 13 to form the image and a circuit board 18 provided in back of the PDP 13 to drive the PDP 13. An optical filter 19 can be provided in front of the display module 10.

The PDP 13 can include a front plate 14 and a rear plate 16 spaced apart from the front plate 14 to form a plasma discharge space 15. The PDP 13 and the circuit board 18 generate high-temperature heat when operated. On the circuit board 18, a power supply part (not shown) to supply power to the PDP 13 typically generates a considerable high-temperature heat.

The optical filter 19 can be provided in front of the PDP 13 to protect the PDP 13 and to filter an image formed on the PDP 13 to display a better image. The optical filter 19 can include a conductive film with a high-conductivity that is provided on a glass substrate to cut electromagnetic interference (EMI) generated from the display module 10.

The front casing 20 can be connected to the rear casing 30 by a fastener such as a screw. In an embodiment of the present general inventive concept, the front casing 20 and the rear casing 30 may support the optical filter 19 and the display module 10.

The rear casing 30 can have a plurality of air slits 31 to discharge heat generated from the display module 10, the air slits can be formed on upper and lower parts of the rear casing 30. The pressure wave generator 40 can be provided on an inner surface of the rear casing 30. The air slits 31 may also be formed on the front casing 20.

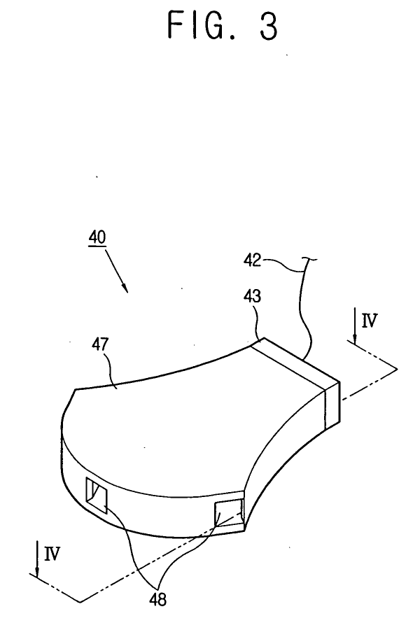

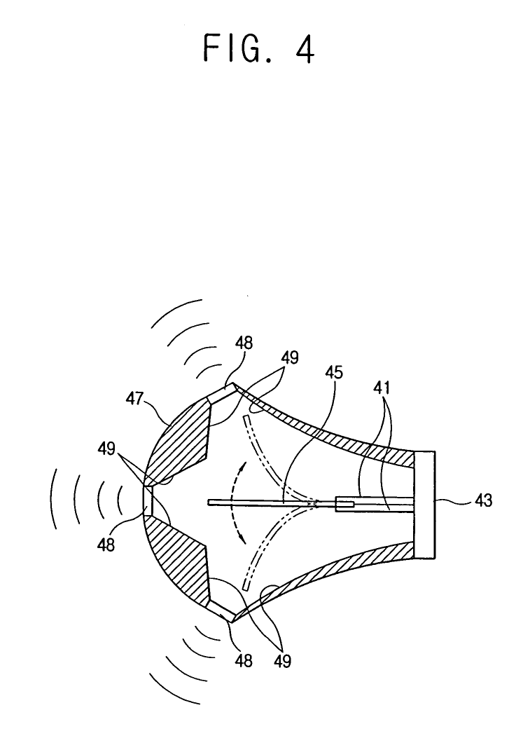

FIG. 3 is a perspective view of a pressure wave generator provided in the display in FIG. 2. FIG. 4 is a sectional view of the pressure wave generator in FIG. 3, taken along the line III-III in FIG. 3.

As shown in FIGS. 3 and 4, the pressure wave generator 40 can generate a pressure wave in a predetermined frequency and generates a turbulent airflow around the display module 10 to facilitate cooling heat generated from the display module 10. The temperature of air around the display module 10 rises due to heat generated from the display module 10, so that the air at the risen temperature is moved up to be discharged to the outside through the air slits 31 and the air from the outside flows into the display module 10 through the air slits 31 provided on the lower part of the rear casing 30. Thus, a natural convection current is generated. However, the natural convention current is not sufficient to efficiently cool the heat from the display module 10, so that an additional cooling apparatus to facilitate cooling the heat is required, as the display module 10 has become larger and larger. Further, it is desirable to prevent operational noise of the cooling apparatus. Thus, the display can include the pressure wave generator including a piezoelectric device supporter 43 to which a predetermined voltage is supplied, and a piezoelectric device 41 that can be connected to the piezoelectric device supporter 43 and generates the pressure wave in a predetermined frequency to prevent the operation noise.

The pressure wave generator 40 can further include a vibrator 45 connected to the piezoelectric device 41 to generate a pressure wave depending on an operation of the piezoelectric device 41. The pressure wave generator 40 can further include a cover 47 forming an external appearance and having at least one hole 48 to induce a pressure wave with concentration.

The pressure wave generator 40 can be disposed inside the rear casing 30 to be spaced apart from the circuit board 18. In am embodiment of the present general inventive concept, the pressure wave generator 40 can be disposed on a lower part of inside of the rear casing 30, so that the pressure wave is transferred to the air flowing through the air slits 31 formed on the lower part of the rear casing 30 to make a heat boundary layer formed around the display module 10 thin and to facilitate a heat transfer from the lower part of the display module 10.

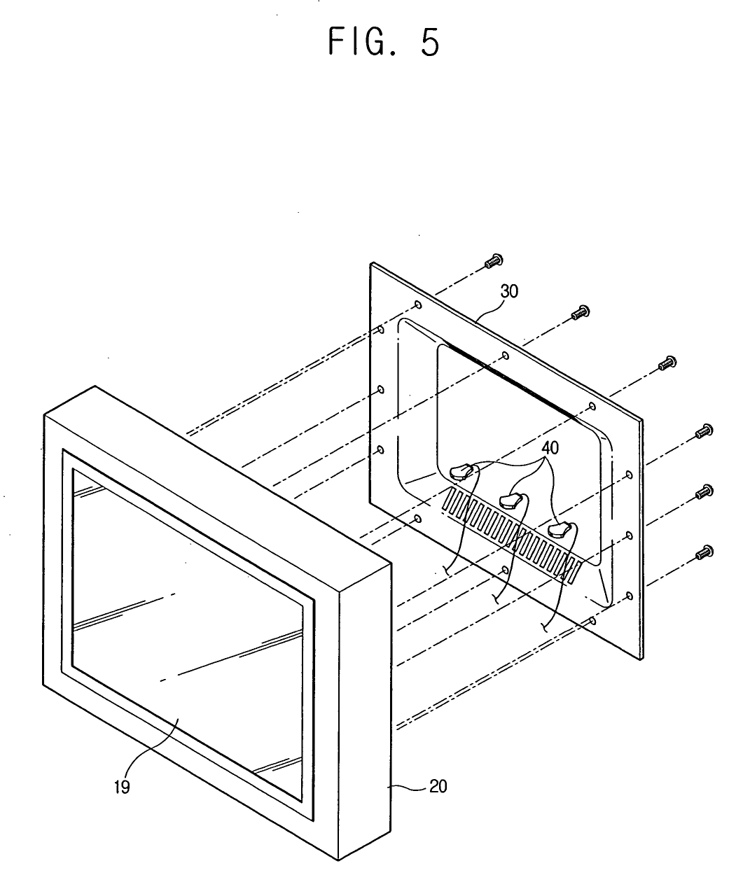

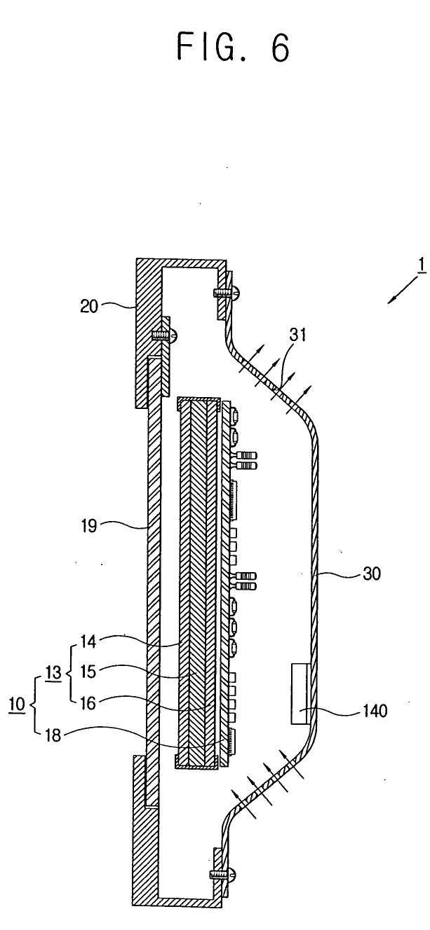

In an embodiment of the present general inventive concept, the pressure wave generator 40 can transfer the pressure wave toward the display module 10. However, the pressure wave generator 40 may be provided in the rear casing 30 to transfer the pressure wave in a direction to which air from the outside flows. The pressure wave generator 40 can be connected to the rear casing 30 by a screw, adhesive bond or adhesive tape or other connection apparatus. Further, the pressure wave generator 40 can be connected to the rear casing 30 using a hook so the pressure wave generator 40 can be easily detached. Either a single pressure wave generator 40 can be used, or multiple pressure wave generators can be used. For example, as shown in FIG. 5, there are three pressure wave generators 40.

The piezoelectric device 41 can be used to generate piezoelectric pressure waves. In the piezoelectric device 41, a distortion is typically generated if electric polarities are produced by input voltage, and the distortion is periodically generated to result in pressure waves. The frequency of the piezoelectric device 41 can be determined by adjusting the size of the piezoelectric device 41. Input voltage is previously determined by supplied power, so that the size of the piezoelectric device 41 is determined to make the frequency of the piezoelectric device 41 in a frequency to prevent operational noise. The frequency needed to prevent operational noise can be substantially lower than audible frequencies (generally 20 Hz˜20 kHz). Actually, the frequency to prevent operation noise can be substantially lower than 50 Hz in which an operation noise is hardly sensed. Further, if the frequency of the piezoelectric device 41 is lower than 10 Hz, a cooling efficiency is too small, so that the frequencies of the pressure wave generator 40 to cool heat of the display module 10 to prevent the operation noise are approximately 10 Hz˜50 Hz. The frequencies of the pressure wave generator 40 can be approximately 25 Hz˜35 Hz.

The piezoelectric device supporter 43 can support the piezoelectric device 41 and can be connected with a cable 42 to supply power to the piezoelectric device 41. The piezoelectric device supporter 43 can be connected to a first end of the piezoelectric device 41 to supply power to the piezoelectric device 41. The piezoelectric device supporter 43 can be connected to the circuit board 18 of the display module 10, so that power is supplied to the piezoelectric device supporter 43, but not limited thereto. The piezoelectric device supporter 43 may be connected to an external power source, so that power is supplied to the piezoelectric device supporter 43. The piezoelectric device supporter 43 can be connected to the rear casing 30 by a fastener such as a screw or other fastening apparatus.

The vibrator 45 can be connected to a second end to be operated in the frequency same as that of the piezoelectric device 41. The vibrator 45 has a thin plate shape and reciprocated in a predetermined distance depending on the distortion of the piezoelectric device 41 to increase the intensity of the pressure wave, but not limited thereto. However, the piezoelectric device 41 can produce the pressure wave without the vibrator 45. The vibrator 45 can be made of elastic material to efficiently produce the pressure wave.

The cover 47 can be used to accommodate the piezoelectric device 41 and the vibrator 45 and can have at least one hole 48 to increase the intensity of the pressure wave produced by the piezoelectric device 41 and the vibrator 45. The cover 47 can have a size in which the vibrator 45 can be rotated. The cover 47 can have a fan shape. If the pressure wave generator 40 has no vibrator 45, the cover 47 is provided to accommodate the piezoelectric device 41.

The hole 48 can be penetrated in a direction in which the pressure wave is formed. The hole 48 can include a funnel 53 having an inner opening greater than an outer opening. There may be only one hole or more than one hole. In the example illustrated in FIG. 4, there are three holes 48.

The funnel 49 is used to concentrate the pressure wave generated by the piezoelectric device 41 and the vibrator 45 and to transfer the pressure wave to the hole 48 with more intensity.

According to the above configuration, a detailed description of an operation of the pressure wave generator 40 of the display 1 follows.

Power is supplied to the display module 10 to form an image. Then, heat is generated from the display module 10 and air flows into and out of the rear casing 30 through the air slits 31 formed on upper and lower parts of the rear casing 30 to cool the heat. A pressure wave is transferred to air around the display module 10 by the pressure wave generator 40, thereby facilitating a heat transfer. Here, the pressure wave generator 40 can be simultaneously operated when power is supplied to the display 1, but not limited thereto. The display 1 is operated after a predetermined time when power is supplied to the display 1. It is understood that, the pressure wave generator 40 may be operated when the temperature of the display module 10 is equal to and higher than a predetermined temperature.

Like this, the display 1 can include the pressure wave generator 40, thereby cooling heat generated from the display module 10 and preventing the operational noise. Further, the pressure wave generator 40 can typically cool the heat more broadly than a cooling fan or a cooing pump that can only partially cool a heat-generated area. As the piezoelectric device 41 is used as the pressure wave generator 40, a mounting space is decreased and it is much easier to mount the pressure wave generator 40 than the cooling fan or the cooling that should be mounted in the vicinity of the area where the heat is generated. In the display 1. The vibrator 45 can be mounted as well, thereby increasing the intensity of the pressure wave and the cooling efficiency. The pressure wave generator 40 can include the cover 47, thereby increasing the intensity of the pressure wave and the cooling efficiency.

FIG. 5 is a perspective view of a plurality of pressure wave generators

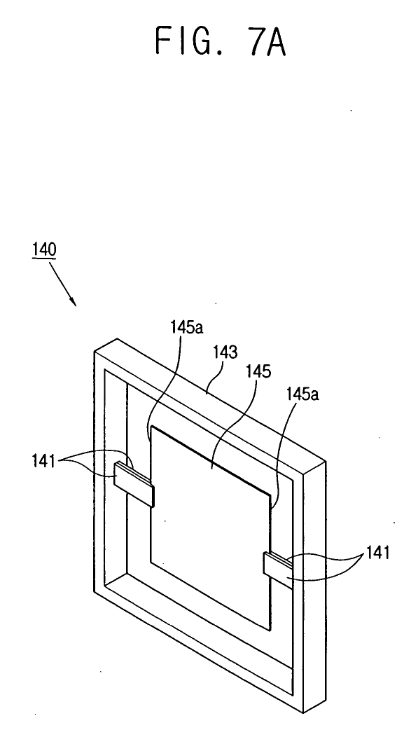

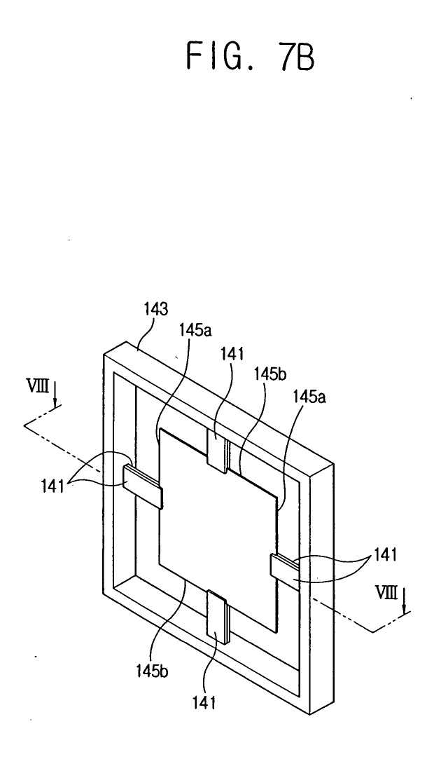

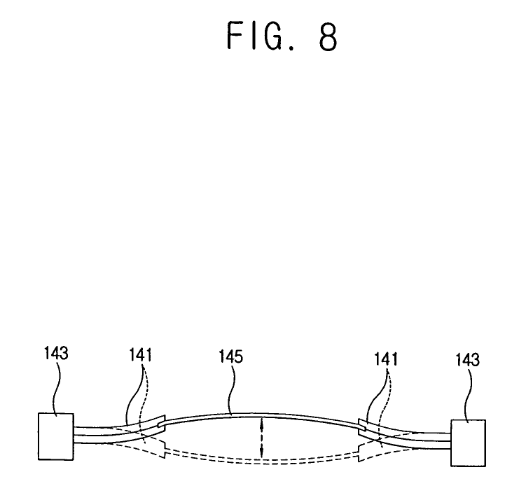

FIG. 6 is a sectional view of a display according to an embodiment of the present general inventive concept. FIG. 7 is a perspective view of a pressure wave generator provided in the display in FIG. 6. FIG. 8 is a sectional view of a display according to an embodiment of the present general inventive concept.

As shown in FIGS. 6 through 8, a pressure wave generator 140 of a display 1 according a further embodiment of the present general inventive concept can include a plurality of piezoelectric devices 141 to support a vibrator 145.

The pressure wave generator 140 can be provided inside the rear casing 30 to be spaced apart from the circuit board 18 of the display module 10. The pressure wave generator 140 can be mounted on a lower inner part of the rear casing 30. The pressure wave generator 140 can transfer a pressure wave toward the display module 10, but not limited to this direction. On the other hand, the pressure wave generator 40 may transfer the pressure wave in a direction to which air from the outside flows.

The piezoelectric devices 141 can be provided at least in a pair connectable to opposite ends of the vibrator 145. That is, as shown in FIG. 7a, the piezoelectric devices 141 may be provide in a pair connectable to first opposite ends 145a of the vibrator 145, but not limited thereto. As shown in FIG. 7b, the piezoelectric devices 141 can be provided in quadruplet connectable to not only the first opposite ends 145a but also to second opposite ends 145b provided in a traverse direction of the first opposite ends 145a. The piezoelectric devices 141 can be connected to each of a middle part of ends of the piezoelectric devices 141 the vibrator 145.

The vibrator 145 can be shaped like a plate and made of elastic material expanded and contracted in a direction where the vibrator is connected to the piezoelectric devices 141. The vibrator 145 can be a thin rubber plate or a thin plate made of special plastic having elasticity. The vibrator 145 can be shaped like a circle or an oval, or any other shape.

The piezoelectric device supporter 143 can be provided outside of the vibrator 145 so that it can be connected to all of the piezoelectric devices 141. More than one piezoelectric device supporter 143 can be provided to support each of the piezoelectric devices 141. The piezoelectric device supporter 143 can be connected to the rear casing 30 by a fastener such as a screw or other fastening mechanism.

The pressure wave generator 40 can include a cover 47 as previously described above.

According to the above configuration, in the pressure wave generator 140 the plurality of piezoelectric devices 141 can vibrate the vibrator 145 in frequencies approximately 10 Hz˜50 Hz, thereby generating the pressure wave. Alternatively, the plurality of piezoelectric devices 141 vibrate the vibrator 145 in frequencies approximately 25 Hz˜35 Hz.

Thus, the display 1 can cool the heat generated from the display module 10 and prevent the operation noise.

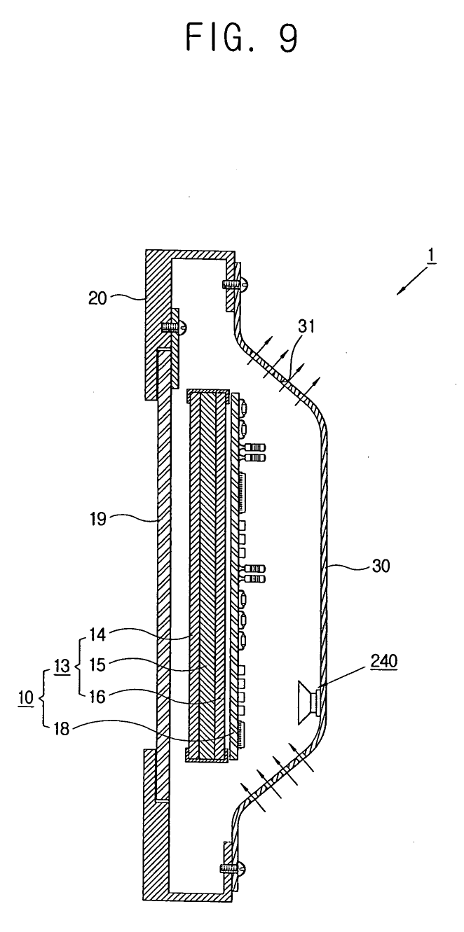

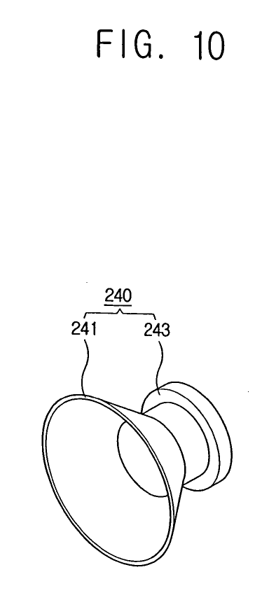

FIG. 9 is a sectional view of a display according to an embodiment of the present general inventive concept. FIG. 10 is a perspective view of a pressure wave generator in FIG. 7, taken along line VIII-VIII in FIG. 7.

As shown in FIGS. 9 through 10, a display 1 according to a further embodiment of the present general inventive concept uses a speaker different from the previously described embodiments.

The pressure wave generator 240 can include a signal generator (not shown) to cool heat generated from the display module 10 and generate a signal in frequencies in which an operation noise of the speaker 241 can be prevented and an amplifier to amplify a signal transmitted from the signal generator and the speaker 241 to generate a pressure wave according to a signal from the signal generator and the amplifier. The pressure wave generator 240 can include a cover (not shown) to form an external appearance of the pressure wave generator 240 and to generate a concentrated pressure wave . The pressure wave generator 240 can further include a speaker supporter 243 to support the speaker 241 with respect to the rear casing 30. The speaker supporter 243 can have a first side connected to the speaker 241 and a second side connected to the rear casing 30 by a fastener such as a screw and the like.

The pressure wave generator 240 can be provided inside the rear casing 30 so as to be spaced apart from the circuit board 18 of the display module 10. The pressure wave generator 240 can be mounted on a lower inner part of the rear casing 30. The pressure wave generator 140 may transfer a pressure wave toward the display module 10, but is not limited to this direction. The pressure wave generator 40 may also transfer the pressure wave in a direction to which air from the outside flows.

The signal generator can generate a signal in which heat generated from the display module 10 can be cooled and the operation noise of the speaker 241 can be prevented. The frequencies used can be approximately 10 Hz˜50 Hz. The frequencies generated from the signal generator can be approximately 25 Hz˜35 Hz. The frequencies generated from the speaker 241 can be approximately 25 Hz˜35 Hz.

The amplifier can amplify a signal generated from the signal generator to transmit the signal to the speaker 241. The amplifier and the signal generator can be mounted on the circuit board 18, but can also be mounted elsewhere as well. The amplifier and the signal generator can also be mounted on the rear casing 30 and on other components of the display 1 as long as they can transmit the signal to the speaker 241.

The speaker 241 can generate a pressure wave according to a signal corresponding to frequencies of the signal generator and amplitudes of the amplifier.

According to the above configuration, the display 1 can cool heat generated from the display module 10 and typically prevent or inhibit the operational noise.

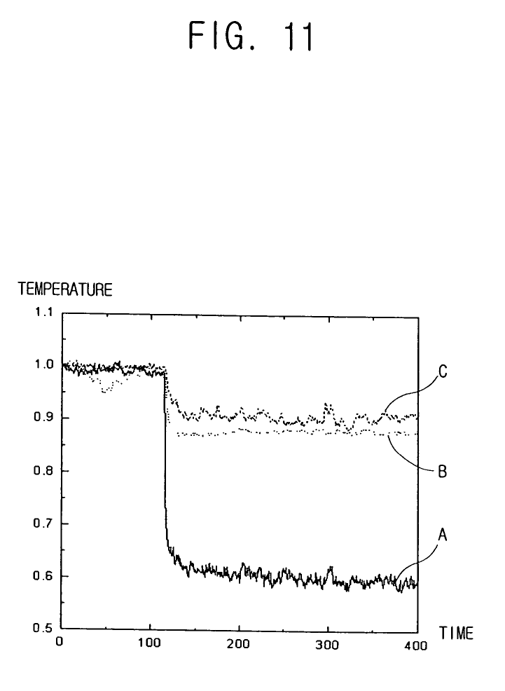

FIG. 11 is a graph showing a cooling efficiency of the pressure wave generator according to the present general inventive concept. The Y-axis indicates non-dimensional temperatures of air discharged from the air slits 31 provided on the upper part of the rear casing 30 and the Y-axis indicates time (in second unit). Here, the non-dimension temperature is a value obtained by measuring temperature of the discharged air in the case that the pressure wave generator 40 and 140 is mounted on the display 1 is divided a temperature of the discharged air measured in the case that the pressure wave generator 40 and 140 is not mounted on the display 1. In this experiment, the frequencies of the pressure wave generator 40 and 140 are set in approximately 25 Hz˜35 Hz, one pressure wave generator 40 and 140 is mounted on a lower part of the rear casing 30 and the temperatures of the discharged air were measured in a middle part A, a left part B and a right part C of the air slits of the rear casing 30. In FIG. 11, A indicates a non-dimensional value of the temperature measured in the middle part of the air slit 31 provided in an upper part of the rear casing 30, B indicates a non-dimensional value of the temperature measured in the left part of the air slit 31 provided in an upper part of the rear casing 30 and C indicates a non-dimensional value of the temperature measured in the right part of the air slit 31 provided in an upper part of the rear casing 30.

As shown in FIG. 11, a cooling efficiency in the middle part A is approximately 40%, cooling efficiencies in the left and right parts B and C are approximately 10%.

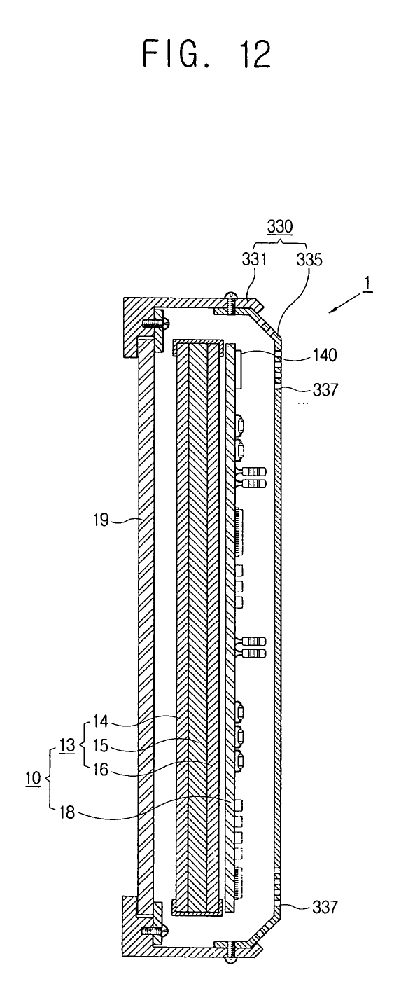

As shown in FIGS. 12 through 14, a display 1 according to a further embodiment of the present general inventive concept can include a display module 10 to form an image, a casing 330 provided outside the display module 10, air slits 337 penetrating the casing 330 and at least one pressure wave generator 140 to generate a pressure wave and transfer the pressure wave toward the air slits 337.

The display module 10 is similar to the display module 10 described above.

The casing 330 can include a front casing 331 provided in front of the display module 10 and a rear casing 335 provided at the back of the display module 10. The casing 330 can further include a middle casing (not shown) provided between the front casing 331 and the rear casing 335.

The front casing 331 can be connected to the rear casing 335 by a fastener such as a screw and the front casing 331 and the rear casing 335 support the optical filter 29 and the display module 10.

The rear casing 335 can have a plurality of air slits 337 to discharge heat generated from the display module 10.

The air slits 337 can be formed on an upper part of the casing 330. For example, air slits 337 can be formed in a plurality on the upper part of the rear casing 335, but can be formed in other locations as well. The air slits 337 may be formed also on the front casing 331. As an aspect of the present general inventive concept, the air slits 337 are formed on the upper part and a lower part of the rear casing 330 to better discharge heat.

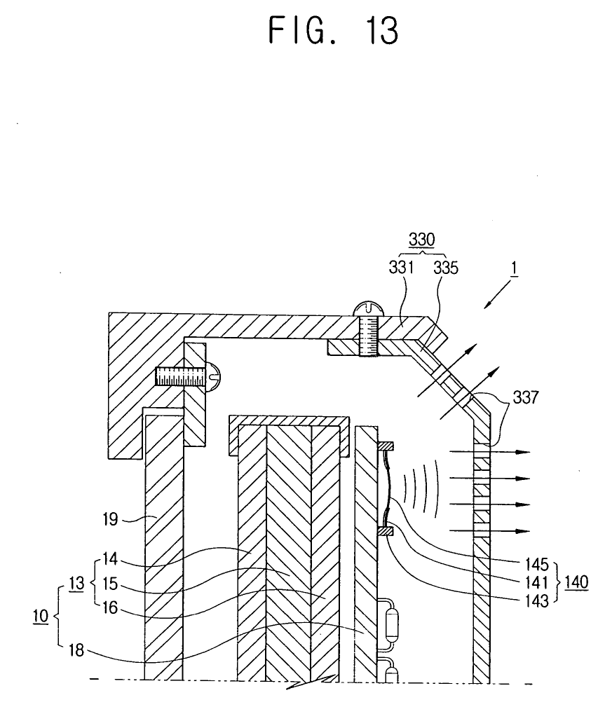

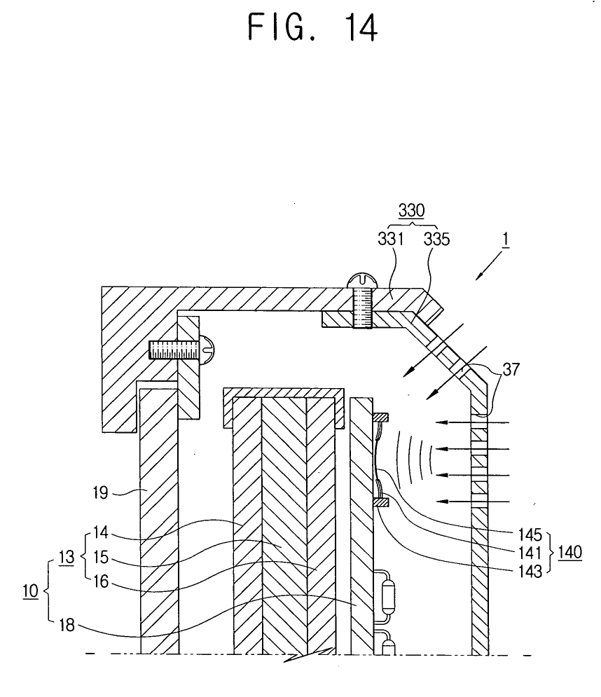

The pressure wave generator 140 can be similar to the one previously described, but is not limited thereto. The pressure wave generator 40 can be provided on at least one of the display module 10 and the casing the pressure wave generator 40 to be spaced apart from the air slits 337 provided on the upper part of the pressure wave generator 140, so that inner air moving upward and accumulated on the upper part of the casing 330 is exchanged with air from the outside. The pressure wave generator 140 can be mounted on the display module 10 to move the pressure wave toward the air slits 337. That is, the pressure wave generator 40 is mounted on the display module 10 to be spaced apart from the air slits 337, so that inner air moving upward and accumulated on the upper part of the casing 330 is exchanged with air from the outside (refer to FIGS. 13 and 14).The pressure wave generator 40 can operate in frequencies of approximately 10 Hz˜50 Hz. The pressure wave generator 40 can also operate in frequencies of approximately 25 Hz˜35 Hz.

Further, the pressure wave generator 40 can be provided outside the air slits 337, which can exchange inner air with the air from the outside through the air slits 337. The pressure wave generator 140 can be mounted on the display 1 without regard a position of the air slits 337. The pressure wave generator 40 can facilitate a natural convection by exerting an effect on air flowing through the air slits 337 provided on the lower part of the casing 330 to cause the natural convection. The pressure wave generator 40 can be connected to the display module 10 with a cable or other connecting apparatus, so that the pressure wave generator 40 is operated simultaneously when power is supplied to the display module 10, but not limited thereto. A separate controller can be provided in the pressure wave generator 140 to control the pressure wave generator 140 according to an inner temperature of the casing 330 and other parts. The pressure wave generator 140 can be connected to the piezoelectric device supporter 143 by a fastener such as a screw and the like. The piezoelectric device supporter 143 of the pressure wave generator 140 can be connected to the circuit board 18 of the display module 10 by a fastener such as a screw and the like.

Referring to FIGS. 13 and 14, a detailed description of an operation of the pressure wave generator of the display follows.

Power is supplied to the display module 10 to form an image. Then, heat is discharged from the display module 10 and inner air of the casing 330 is heated, so that the heated inner air is moved up and accumulated on an inner upper part of the casing 330. At this time, the pressure wave generator 140 is operated to exchange inner air of the casing 330 with air from the outside through the air slits 337. As shown in FIG. 13, the vibrator 145 of the pressure wave generator 140 is moved toward the air slits 337, so that the pressure wave is generated toward the outside and the inner air can be moved toward the outside. As shown in FIG. 14, the vibrator 145 of the pressure wave generator 140 is moved in an opposite direction of the air slits 337, so that the pressure wave is moved from the outside toward the inside and the air from the outside is moved toward the inside. At this time, the inner air is exchanged wit the air from the outside by the pressure wave generator 140, so that the inside of the casing 330 can be cooled. The inner air heated by the display module 10 and moved upward heats the upper part of the casing 330, which is prevented by the pressure wave generator 40.

As described above, according to the present general inventive concept, the heat generated from the display module can be cooled and the operational noise can be prevented.

Further, the cover is provided on the pressure wave generator, thereby increasing the intensity of the pressure wave and the cooling efficiency.

Moreover, heating of the upper part of the casing can be easily prevented.

Although a few embodiments of the present general inventive concept have been shown and described, it will be appreciated by those skilled in the art that changes may be made in these embodiments without departing from the principles and spirit of the general inventive concept, the scope of which is defined in the accompanying claims and their equivalents.

1. A display including a display module to form an image, the display comprising:
a front casing provided in front of the display module;
a rear casing provided at a back of the display module;
an air slit formed on at least one of the front casing and the rear casing; and
at least one pressure wave generator that is provided between the front casing and the rear casing to cool heat generated from the display module and to generate a pressure wave in a frequency in which an operational noise of the pressure wave generator is prevented.

2. The display according to claim 1, wherein the pressure wave generator comprises a piezoelectric device that is operated in a frequency and a piezoelectric device supporter that supports the piezoelectric device and is connected with a cable to supply power to the piezoelectric device.

3. The display according to claim 2, wherein the pressure wave generator further comprises a vibrator that is connected to the piezoelectric device and generates a pressure wave depending on an operation of the piezoelectric device.

4. The display according to claim 3, wherein the pressure wave generator is provided at least in a pair each to be connected to first opposite ends of the vibrator.

5. The display according to claim 4, wherein the pressure wave generator is provided at least in quadruplet each to be connected to the first opposite ends of the vibrator and second opposite ends provided in a traverse direction of the first opposite ends.

6. The display according to claim 4, wherein the vibrator has a substantially plate shape and made of elastic material to be expanded and contracted in a direction in which the vibrator is connected to the piezoelectric device.

7. The display according to claim 3, wherein the cable connected with the piezoelectric device is connected to a circuit board of the display module to supply power to the piezoelectric device.

8. The display according to claim 1, wherein the pressure wave generator comprises a signal generator to generate a signal corresponding to the frequency, an amplifier to amplify a signal received from the signal generator and a speaker to generate a pressure wave according to a signal received from the signal generator and the amplifier.

9. The display according to claim 1, wherein the pressure wave generator comprises a cover that forms an external appearance of the pressure wave generator and has at least one hole to generate the pressure wave with concentration.

10. The display according to claim 9, wherein the hole of the cover is shaped like a funnel having an inner opening broader than an outer opening.

11. The display according to claim 10, wherein the pressure wave generator is provided inside of the rear casing to be spaced apart from the circuit board of the display module.

12. The display according to claim 11, wherein the pressure wave generator is provided on an inner lower part of the rear casing.

13. The display according to claim 1, wherein the air slit is provided on the rear casing and the pressure wave generator is provided inside the rear casing to be positioned in the vicinity of the air slit.

14. The display according to claim 1, wherein the pressure wave generator generates a pressure wave in frequencies approximately 10 Hz through 50 Hz.

15. The display according to claim 14, wherein the pressure wave generator generates a pressure wave in frequencies approximately 25 Hz through 35 Hz.

16. A pressure wave generator comprising:
at least one piezoelectric device;
a vibrator that is connected to a first end of the piezoelectric device to generate a pressure wave in a predetermined frequency by the piezoelectric device; and
a piezoelectric device supporter that is connected to a second end of the piezoelectric device to support the piezoelectric device.

17. The pressure wave generator according to claim 16, wherein the piezoelectric device supporter is provided outside the vibrator, and
the piezoelectric device is provided in a plurality between the piezoelectric device supporter and the vibrator.

18. The pressure wave generator according to claim 17, wherein the plurality of piezoelectric devices is provided between the piezoelectric device supporter and the vibrator at equal intervals.

19. The pressure wave generator according to claim 16, wherein the vibrator is substantially plate shaped and made of elastic material that is expands and contracts in a direction in which the vibrator is connected to the piezoelectric device.

20. The pressure wave generator according to claim 17, wherein an end of each of the plurality of piezoelectric devices is reciprocated simultaneously in the same direction with respect to the piezoelectric device supporter.

21. The pressure wave generator according to claim 16, wherein frequencies of a pressure wave generated by the vibrator are approximately 10 Hz through 50 Hz.

22. A display including a display module to form an image and a casing provided outside the display module, the display comprising:
an air slit formed on the casing; and
at least one pressure wave generator to generate a pressure wave and transfer the pressure wave toward the air slit, the pressure wave generator including:
at least one piezoelectric device;
a vibrator that is connected to a first end of the piezoelectric device to generate a pressure wave in a predetermined frequency by the piezoelectric device; and
a piezoelectric device supporter that is connected to a second end of the piezoelectric device to support the piezoelectric device.

23. The display according to claim 22, wherein the piezoelectric device supporter is provided outside the vibrator, and
the pressure wave generator is provided in a plurality between the piezoelectric device supporter and the vibrator.

24. The display according to claim 22, wherein the vibrator has a substantially plate shape and made of elastic material to be expanded and contracted in a direction in which the vibrator is connected to the piezoelectric device.

25. The display according to claim 23, wherein an end of each of the plurality of piezoelectric devices is reciprocated simultaneously in the same direction with respect to the piezoelectric device supporter.

26. The display according to claim 22, wherein the pressure wave generator is provided on at least one of the display module and the casing to be spaced apart from the air slit.

27. The display according to claim 26, wherein the air slit is provided on an upper part of the casing, and
the pressure wave generator is provided in the display module to transfer a pressure wave generated from the pressure wave generator toward the air slit.

28. A display, comprising:
a display unit;
an air vent on a surface of the display unit; and
a pressure wave generator to generate a pressure wave inside the display unit that exits the display via the air vent.

29. The display according to claim 28, wherein the pressure wave generator comprises:
a piezoelectric device inside the display unit; and
a vibrator connected to the piezoelectric device.

30. The display according to claim 29, wherein the vibrator is plate shaped.

31. A display, comprising:
a display screen;
casing means housing the display screen;
wave generation means to generate a pressure wave inside the casing means; and
ventilation means provided on the casing means to allow the pressure wave to exit the casing means.

32. A method to reduce heat in a display, the method comprising:
generating a pressure wave inside a casing surrounding a display; and
transferring heat out of the casing via the pressure wave.

33. The method according to claim 32, wherein the pressure wave is generated in a frequency to prevent operational noise of the display.

34. The method according to claim 32, wherein the generating is performed by a piezoelectric device attached to a vibrator.

35. The method according to claim 32, wherein the pressure wave is generated in a frequency to prevent noise.
